(19) United States
(12) Patent Application Publication
(10) Pub. No.: US 2005/0265135 A1
(43) Pub. Date: Dec. 1, 2005

(54) Recording and reproducing apparatus and recording and reproducing method

(75) Inventor: Masahiro Yamada, Nishitama-gun (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/136,720

(22) Filed: May 25, 2005

(30) Foreign Application Priority Data
May 28, 2004 (JP) 2004-159498

(51) Int. Cl. G11B 5/09; G11B 7/00

(52) U.S. Cl. 369/30.01; 369/47.22; 369/47.1; 369/53.2

(57) ABSTRACT

A recording and reproducing apparatus having a recording unit which has a recording region for recording information, a computing unit divides the recording region of the recording unit into a first region and a second region for repeated recording in a direction from a head to an end point, and determines addresses of the respective regions such that the second region has a capacity of an integral number times of a packet capacity which is a processing unit for recording and reproducing processing, and a control unit which controls the recording unit, at the time of continuously recording information so as to be over the recording capacity onto the recording unit, so as to carry out recording of information over an entire surface of the recording region as a first recording, and so as to repeatedly continue recordings at the second region.

### CROSS-REFERENCE TO RELATED APPLICATIONS

This application is based upon and claims the benefit of priority from prior Japanese Patent Application No. 2004-159498, filed May 28, 2004, the entire contents of which are incorporated herein by reference.

### BACKGROUND OF THE INVENTION

1. Field of the Invention

The present invention relates to a recording and reproducing apparatus which records information onto a recording region and reproduces the information, and in particular, to a recording and reproducing apparatus and a recording and reproducing method which set an address at the time of continuously carrying out recording of a capacity over the capacity of the recording region for a long time.

2. Description of the Related Art

Recently, recording and reproducing apparatuses, such as a hard disk recorder, a DVD (Digital Versatile Disc) recorder, or the like, which handle digital image information have been broadly diffused, and various methods of research and development have been carried out, and have been developed into products. In such a recording and reproducing apparatus for digital image information, for example, there is a technique, which is called timeshift viewing and which reproduces recorded picture at a time made to go back from the picture-recorded point while continuously recording image information onto a hard disk drive. Here, in order to continue to picture-record the image information of a capacity over the capacity of the hard disk, when a recorded quantity reaches a predetermined value, the new data must be recorded while erasing the oldest data.

Picture-recording processings which are the same as this are shown in U.S. Reissue Pat. No. RE36801 and U.S. Pat. No. 6,138,147, and there have been sampled in both of those that when a recorded quantity reaches a predetermined value, the new data is recorded while erasing the oldest data. Namely, similar descriptions are shown at line 29 in the 6^{th} column in U.S. Reissue Pat. No. RE36801, and at line 3 in the 20^{th} column in U.S. Pat. No. 6,138,147.

However, in the conventional art described above, at the time of carrying out continuous recording processing for timeshift viewing, because the oldest information is deleted when recorded information reaches a predetermined quantity, and new picture-recording information is recorded, all the picture-recording information at a point in time when the recording is started is lost, and there is the problem that it is impossible to know what the picture-recording information is concerned with.

Furthermore, at the time of carrying out long time recording, because the recording is not exactly completed for each packet capacity which is a processing unit for recording and reproducing processing at around the time when recorded information reaches a predetermined quantity, one packet is picture-recorded so as to be divided. Therefore, in a control unit, address computation must be carried out each time, and further, because a seek time of the disk is made longer, or the like, there is the problem that the operation is made unstable.

### BRIEF SUMMARY OF THE INVENTION

According to an aspect of the present invention, there is provided a recording and reproducing apparatus comprising: a recording unit which has a recording region for recording information; a computing unit which, at the time of determining addresses of respective regions of a head region which starts from a first address which is a head address of the recording region of the recording unit and ends at a second address, and a repeated recording region which starts from the second address and ends at a third address which is a last address of the recording region, determines the second address by computation such that a capacity of the repeated recording region is made to be an integral number times of a packet capacity which is a processing unit for recording and reproducing processing, and a capacity of the head region is made to be a capacity in which the capacity of the repeated region is subtracted from the capacity of the recording region; and a control unit which, at the time of continuously recording information so as to be over the recording capacity of the recording region onto the recording unit, controls the recording unit so as to carry out recording of information onto an entire surface of the recording region from the first address up to the third address as a first recording, and so as to repeatedly continue recordings at the repeated recording region from the second address up to the third address as recordings after the recording reaches the third address, and which controls the recording unit so as to reproduce the information recorded at the recording unit.

According to another aspect of the present invention, there is provided a recording and reproducing apparatus comprising: a recording unit which has a recording region for recording information; a computing unit which sets files having predetermined capacities for recording the information onto the recording region of the recording unit, and which determines addresses of the plurality of files so as to store the information by the plurality of files; and a control unit which, at the time of continuously recording information so as to be over the recording capacity onto the recording unit, controls the recording unit so as to record the information for each one of the plurality of files over an entire surface of the recording region as a first recording, and after files which can be recorded onto the recording region are recorded, so as to leave the file recorded at the first time, and to sequentially set the plurality of new files while deleting the files recorded from the second recording on, and to record the information onto the recording unit for each one of the plurality of the new files, on the basis of the respective addresses computed at the computing unit, and which controls the recording unit so as to reproduce the information recorded at the recording unit.

### BRIEF DESCRIPTION OF THE SEVERAL VIEWS OF THE DRAWING

FIG. 1 is a block diagram showing one example of a configuration of a recording and reproducing apparatus according to an embodiment of the present invention;

FIG. 2 is an explanatory diagram showing one example of a recording method of the recording and reproducing apparatus according to the embodiment of the invention;

FIG. 3 is a flowchart showing one example of the recording method of the recording and reproducing apparatus according to the embodiment of the invention;

FIG. 4 is an explanatory diagram showing one example of files which the recording and reproducing apparatus according to the embodiment of the invention records; and

FIG. 5 is a flowchart showing another example of the recording method of the recording and reproducing apparatus according to the embodiment of the invention.

### DETAILED DESCRIPTION OF THE INVENTION

Hereinafter, an embodiment of the present invention will be described in detail with reference to the drawings.

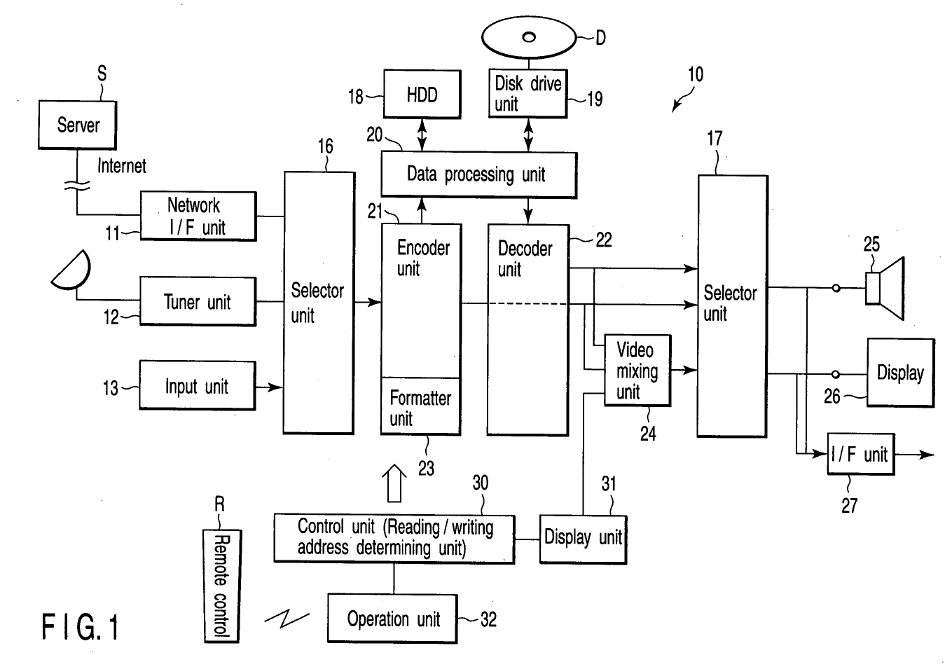

A recording and reproducing apparatus according to the present invention will de described in detail hereinafter with a hard disk recorder 10 having a DVD recorder function or the like as shown in FIG. 1 being as an example.

<Recording and Reproducing Apparatus according to One Embodiment of the Present Invention>

First, a configuration of the recording and reproducing apparatus according to the present invention will be described with reference to the drawings. FIG. 1 is a block diagram showing one example of the configuration of the recording and reproducing apparatus according to an embodiment of the present invention.

(Configuration)

In this embodiment, a recording and reproducing apparatus 10 is shown as an apparatus which can handle both of a DVD-RAM and a hard disk as recording media. However, the hard disk and the DVD-RAM may be replaced with a recording medium composed of, for example, a semiconductor memory, or the like. To broadly divide respective blocks in FIG. 1, main blocks in a recording unit are shown on the left side, and main blocks in a reproducing unit are shown on the right side.

The recording and reproducing apparatus 10 of FIG. 1 has two types of disk drive units. First, a disk drive unit 19 which drives to rotate an optical disk D serving as a first medium which is an information recording medium on which video files can be constructed, and which executes reading and writing information is provided. Further, a hard disk drive unit 18 which drives a hard disk serving as a second medium is provided. A control unit 30 can supply recording data to the disk drive unit 19 and the hard disk drive unit 18, and can receive reproduced signals. The disk drive unit 19 has a rotation control system, a laser driving system, an optical system, or the like with respect to the optical disk D.

A data processing unit 20 handles data in units of recording or reproducing, and includes a buffer circuit, a modulation/demodulator circuit, an error correction circuit, or the like.

Further, the recording and reproducing apparatus 10 of FIG. 1 has, as main components, an encoder unit 21 configuring the recording side, a decoder unit 22 configuring the reproducing side, and a control unit 30 controlling the operation of the main body of the apparatus.

The recording and reproducing apparatus 10 has, as the input side a network I/F unit 11 which is for connecting to a server S or the like via, for example, Internet or the like, a tuner unit 12 which tunes broadcast signal via an antenna and demodulates it, and which outputs picture signal and voice signal, and an input unit 13 which is for receiving a luminance signal, a color-difference signal, a picture signal such as a composite signal or the like, and a voice signal. The inputs of those are controlled by a selector 16 controlled by the control unit 30 or the like, and are selectively supplied to the encoder unit 21. Namely, an external analog video signal and an external analog audio signal from the input unit 13, or an analog video signal and an analog audio signal from the TV tuner 12 are inputted to the encoder unit 21 via the selector 16.

The encoder unit 21 has analog digital converters for video and audio which digitize the analog video signal and the analog audio signal inputted by the selector 16, a video encoder, and an audio encoder. The encoder unit 21 further includes a sub-image encoder as well.

The output of the encoder unit 21 is converted into a predetermined DVD-RAM format at a formatter unit 23 including a buffer memory when the output is recorded onto a DVD, and is supplied to the data processing unit 20 described above.

Note that, when directly compressed digital video signal and digital audio signal are directly inputted to the encoder unit 21, the encoder unit 21 can directly supply the compressed digital video signal and digital audio signal to the formatter unit 23. Further, the encoder unit 21 can directly supply a digital video signal and a digital audio signal which have been analog-to-digital converted to a video mixing unit 24 or a selector unit 17.

At the video encoder included in the encoder unit 21, a digital video signal is converted into a digital video signal compressed at a variable bit rate based on the MPEG2 or MPEG1 standard. A digital audio signal is converted into a digital audio signal compressed at a fixed bit rate in accordance with the MPEG or AC-3 standard, or into a linear PCM digital audio signal.

In the case in which a sub-image signal is inputted from the input unit 13 (for example, a signal from a DVD video player with an separate output terminal for sub-image signals, or the like), or in the case in which a DVD video signal having such a data structure is broadcast, and the signal is received on the TV tuner 12, a sub-image signal in the DVD video signal is encoded by a sub-image encoder (run length coding) to be a bitmap of the sub-image.

At the time of recording onto the optical disk D in accordance with the DVD-recording standard (for example, the standard for recording onto a DVD-RAM, a DVD-R, a DVD-RW, or the like), the encoded digital video signal, digital audio signal, and sub-image data are made into packs (2048 bytes or the like) at the formatter unit 23 so as to be a video pack, an audio pack, and a sub-image pack, and those are further made to get together to be converted into a format specified in accordance with the DVD-recording standard (for example, the standard for recording onto a DVD-RAM, a DVD-R, a DVD-RW, or the like).

In a case of recording on the optical disk D in accordance with another standard, or in a case of recording on the hard disk drive unit 18, a digital video signal, a digital audio signal, or the like which have been encoded are converted into formats in accordance with respective desired standards at the formatter unit 23. For example, in the case of recording by a transport stream in accordance with the MPEG2 Systems standard, making data into packets in units of 188 bytes, insertion of a table of PAT, PMT, or the like, or the like are carried out.

Here, the apparatus of FIG. 1 supplies information formatted at the formatter unit 23 in this way and the prepared management information to the hard disk drive unit 18 or the disk drive unit 19 via the data processing unit 20, and can record the information and the management information onto the hard disk drive unit 18 or the optical disk D. Further, the apparatus of FIG. 1 can record the information which has recorded onto the hard disk drive unit 18 or the optical disk D, onto the optical disk D or the hard disk via the data processing unit 20 and the disk drive unit 19.

Further, with respect to a plurality of programs recorded onto the hard disk or the optical disk D, editing processings in which some of those are deleted, different programs among those are joined to one another, and the like can be carried out.

The control unit 30 includes an MPU (Micro Processing Unit) or a CPU (Central Processing Unit), a ROM into which a control program or the like is written, and a RAM for providing a work area needed for executing the program.

The MPU of the control unit 30 carries out readout/writing address determination processing at the hard disk drive unit 19 which is the embodiment of the present invention and which will be described in detail later, by using the RAM as a work area, in accordance with the control program stored in the ROM. Furthermore, it is preferable that defective location detection, unrecorded region detection, picture-recording information recorded position setting, UDF recording, AV address setting, or the like are carried out.

Further, the control unit 30 has an information processing unit needed for controlling the entire system, and has the work RAM described above. Moreover, as another embodiment, it is preferable that the control unit 30 has, in addition to a directory detecting unit and a management information control unit for the time of editing and recording, which are not illustrated, a VMG (entire video management information) information preparing unit, a copy related information sensing unit, a copy and scrambling information processing unit (RDI processing unit), a packet header processing unit, a sequence header processing unit, an aspect ratio information processing unit, or the like.

The contents to be reported to a user among the executed results at the MPU is displayed on a display unit 31 of the recording and reproducing apparatus, or is displayed on a display 26 in an OSD (On Screen Display) manner. Further, the control unit 30 has an operation unit 32 providing an operation signal for operating the apparatus. It is preferable that the operation unit 32 further includes a remote control.

Note that the timings in which the control unit 30 controls the disk drive unit 19, the hard disk drive unit 18, the control unit 30, the encoder unit 21 and/or the decoder unit 22, or the like can be executed on the basis of time data from an unillustrated STC (System Time Clock). Operations of recording and reproducing are usually executed so as to be synchronized with a time clock from the STC. However, other processings may be executed in timings independent of the STC.

The decoder unit 22 has a separator which separates and fetches respective packs from a DVD formatted signal having a packet structure, a memory used at the time of separating packs and executing other signal processings, a V decoder decoding main image data (contents of the video pack) separated at the separator, an SP decoder decoding sub-image data (contents of the sub-image pack) separated at the separator, and an A decoder decoding audio data (contents of the audio pack) separated at the separator. Further, the decoder unit 22 is equipped with a video processor which appropriately synthesizes a decoded sub-image onto a decoded main image, and which superposes a menu, a highlight button, a caption, and other sub-images on the main image, and outputs it.

An output video signal of the decoder unit 22 is inputted to the video mixing unit 24. At the video mixing unit 24, synthesis of text data is carried out. Further, a line for directly fetching signals from the TV tuner 12 and the input unit 13 as well is connected to the video mixing unit 24. An unillustrated frame memory used as a buffer is connected to the video mixing unit 24. When an output of the video mixing unit 24 is supplied to the selector unit 17, and is selected by the selector unit 17, the output is supplied to and displayed on the display 26, or is supplied to an external apparatus via the I/F (interface) unit 27.

An output audio signal from the decoder unit 22 is converted into an analog signal by an unillustrated digital-to-analog converter via the selector 17, and is supplied to a speaker 25, or is supplied to an external apparatus via the I/F unit 27. The selector 17 is controlled by a select signal from the control unit 30. In accordance therewith, at the time of monitoring the digital signals from the TV tuner 12 and the input unit 13, the selector 17 can directly select a signal passed through the encoder unit 21.

Note that the formatter unit 23 of the encoder unit 21 prepares respective demarcated information during the time of recording, and periodically transmits the demarcated information to the MPU of the control unit 30 (information at the time of interrupting the head of GOP, or the like). The demarcated information are a number of packs of VOBUs, an end address of an I picture from the head of VOBUs, a time of reproducing the VOBUs, or the like.

The data processing unit 20 supplies data in units of packs or packets (188 bytes or the like) from the formatter 23 of the encoder unit 21 to the disk drive unit 19 or the hard disk drive unit 18. Further, the MPU of the control unit 30 prepares management information needed for reproducing the recorded data, and transmits the prepared management information to the data processing unit 20 at the time of recognizing a command to complete data recording. In accordance therewith, the management information is recorded onto a disk. Accordingly, when encoding is being carried out, the MPU of the control unit 30 receives information in units of data (demarcated information or the like) from the encoder unit 21. Further, the MPU of the control unit 30 recognizes the management information (a file system) read out of the optical disk and the hard disk when recording is started, and recognizes unrecorded areas of the respective disks, and sets data recorded areas in the disks via the control unit 30.

(Address Setting for Repeated Recording Region)

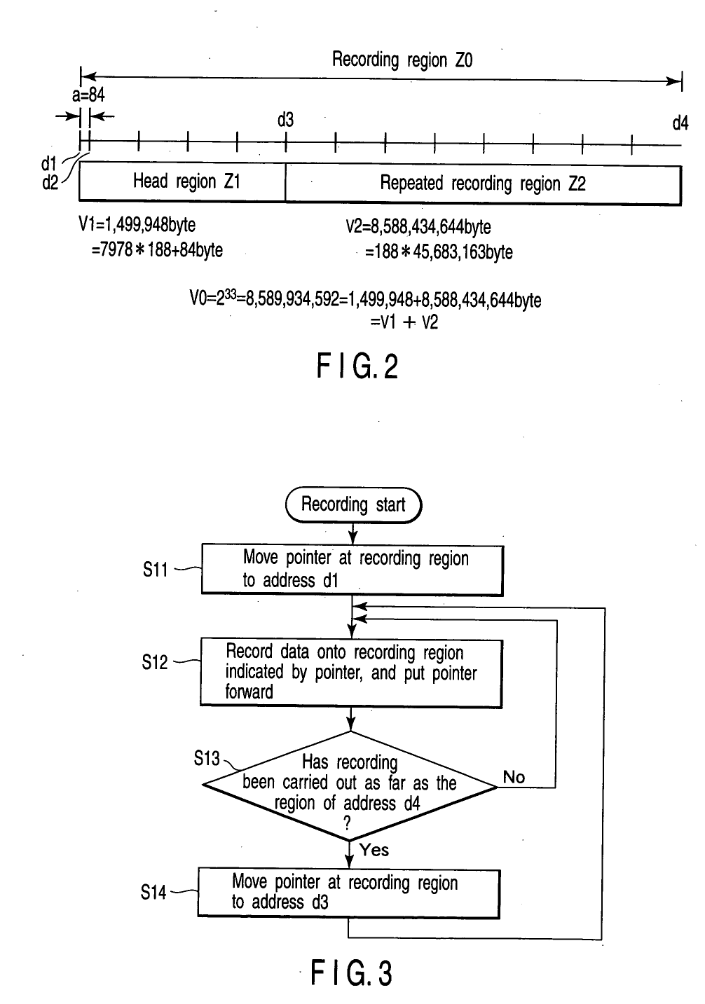

Next, setting of an address at the time of continuous recording processing at the recording and reproducing apparatus 10 according to the embodiment of the invention will be described in detail hereinafter with reference to the drawings. FIG. 2 is an explanatory diagram showing one example of a recording method of the recording and reproducing apparatus according to the embodiment of the invention. FIG. 3 is a flowchart showing one example of the recording method of the recording and reproducing apparatus according to the embodiment of the invention.

With respect to the recording and reproducing apparatus 10 according to the embodiment of the invention, as shown in FIG. 2, one example of a storage capacity is shown hereinafter, and a storage region Z₀ (which is, for example, for continuous recording for timeshift viewing) of the hard disk driver 18 is divided into a head region Z₁ and a repeated recording region Z₂, and in particular, an address d3 is computed such that the latter repeated recording region Z₂ is made to have a capacity of integral number times of the packet capacity (188 bytes). On the other hand, the head region Z₁ is not made to be integral number times of the packet capacity (188 bytes), and here, the head region Z₁ includes 84 bytes in surplus.

Namely, here, a capacity V₀ of the storage region Z₀ is

$$\begin{matrix}{V}_{0} = {2}^{33} = 8 \text{,} 589 \text{,} 934 \text{,} 592 bytes \\ = 1 \text{,} 499 \text{,} 948 + 8 \text{,} 588 \text{,} 434 \text{,} 644 bytes \\ = {V}_{1} + {V}_{2} ,\end{matrix}$$

and a capacity V₁ of the head region Z₁ is
V₁=1,499,948 bytes=7978*1,499,864+84 bytes, and a capacity V₂ of the repeated recording region Z₂ is
V₂=8,588,434,644 bytes=188*45,683,163 bytes.

In this way, continuous recording processing in a case in which the storage region Z₀ of the hard disk drive unit 18 is divided into the head region Z₁ and the repeated recording region Z₂, and for example, timeshift viewing or the like is designated by a user, or the like will be described by using the flowchart of FIG. 3. In the flowchart of FIG. 3, when information (for example, image/voice information from the tuner unit 12) is continuously recorded so as to be over the capacity of the storage region Z₀, when the information to be recorded is within a range of the storage region Z₀ in accordance with the operation of the program stored in an unillustrated ROM of the control unit 30 or the like shown in FIG. 1, a pointer of the recording region is moved to an address d1 in order to carry out recording from the head region Z₁ of the storage region Z₀ (S11). Then, the pointer is made to progress while recording information on the recording region indicated by the pointer (S12). When the recording progresses, and the pointer records as far as the region of an address d4 (S13), next, the pointer at the recording region is made to jump to the head region Z₁, and is moved to the address d3 in order to carry out recording from the repeated recording region Z₂ (S14). Thereafter, when the pointer records as far as the region of the address d4 again in accordance with the progress of recording (S13), the routine jumps to step S12 again, new information is continued to be recorded while deleting recorded information at the repeated recording region Z₂.

At that time, as described above, because the address d3 is computed such that the capacity of the repeated recording region Z₂ is made to be a capacity which is integral number times of the packet capacity (188 bytes), a packet ends on the way of the trailing end portion of the repeated recording region Z₂, and because there is no case in which the remaining packets are positioned at the head region, it is possible to simplify address computation, and there is no need to read out one packet so as to be separated into two areas of the end and the beginning of the recording region, and in accordance therewith, the effect of a seek time of the disk can be avoided, and rapid and stable recording processing can be carried out.

Note that the one example of a packet capacity here is 188 bytes. However, it is not limited thereto, and for example, 192 bytes, 130 bytes, 132 bytes, 134 bytes, or the like are preferable.

Further, the long time recording here is a time in which all the recording capacity Z₀ prepared for timeshift viewing at the hard disk drive unit 18 is used up due to the recording, and for example, when HD picture contents of 3 MB/s is recorded onto a hard disk driver of 30 gigabytes, it is 30/3=10 k seconds=about 2.8 hours, and in this case, about 2.8 hours is to be the long time recording.

Further, here, because recordings from the second recording on are carried out at the repeated recording region Z₂, recorded information at the first time remains at the head region Z₁, and in accordance therewith, even if picture-recording is carried out for a long time, for example, because the first screen of the picture-recording is stored, the contents of the picture recorded by the user himself/herself can be easily known due to the picture-recorded image being reproduced later by the user. At that time, the capacity of the head region Z₁ is preferably a capacity in which moving picture information of at least one screen or more can be stored.

(Recording Processing for Each One of a Plurality of Files)

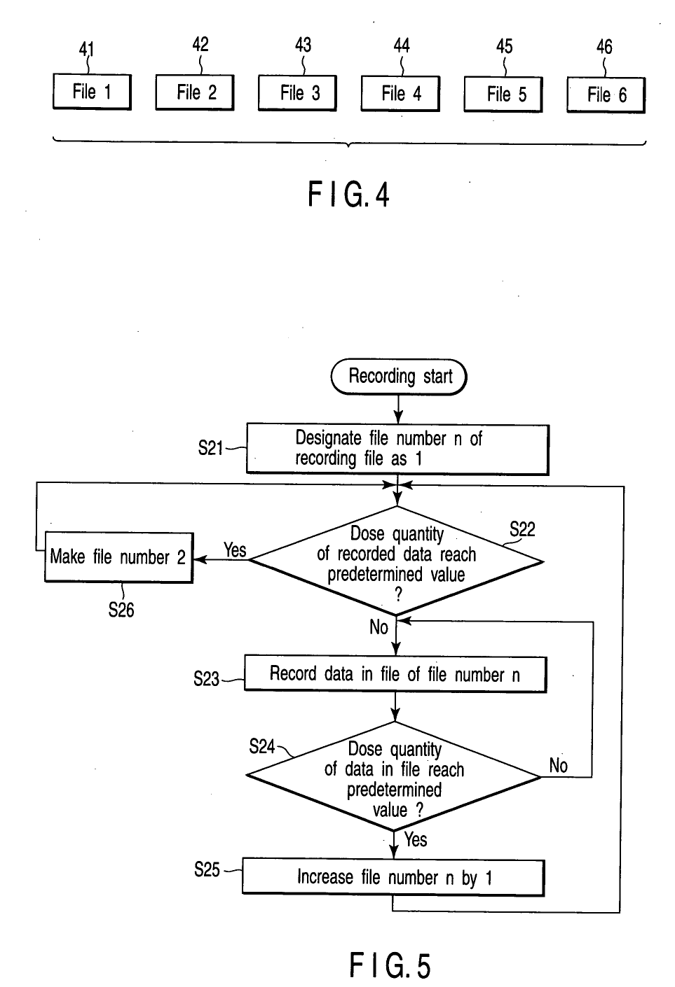

Recording processing for each one of a plurality of files at the time of continuous recording processing at the recording and reproducing apparatus 10 according to the embodiment of the invention will be described in detail hereinafter with reference to the drawings. FIG. 4 is an explanatory diagram showing one example of files which the recording and reproducing apparatus according to the embodiment of the invention records, and FIG. 5 is a flowchart showing another example of the recording method of the recording and reproducing apparatus according to the embodiment of the invention.

With respect to processing at the time of another continuous recording processing of the recording and reproducing apparatus 10 according to the embodiment of the invention, as shown in FIG. 4, a case will be described in which, at the storage region Z₀ of the hard disk drive unit 18, a plurality of files 1 through n (41-46) are set, and information are continuously recorded for each file. Here, various sizes as the sizes of the files are available, and for example, one picture in moving picture information, or 1GOT, or a capacity of one second moving picture information, or the like are preferable.

The continuous picture-recording processing carried out for each one of the plurality of files in this way at the storage region Z₀ of the hard disk drive unit 18 will be described hereinafter by using the flowchart of FIG. 5. When long time recording processing is carried out, for example, for timeshift viewing in accordance with the operation of the program stored in an unillustrated ROM or the like of the control unit 30 shown in FIG. 1, a file number n of the recording file is designated as 1, and information recording processing is started from the file 1 (41) (S21), and when the entire region of the storage region Z₀ is not used yet (S22), information is recorded on the file 1 (S23). When the quantity of data of the file 1 is filled up (S24), the file number n is raised, for example, to be a file 2 (42), and it is verified that files which the region Z₀ of the hard disk drive unit 18 can set remains (S22), and in the same way, information are recorded for each file. At step S22, files which the region Z₀ of the hard disk drive unit 18 can set are not left at all, and when the quantity of recorded data reaches a predetermined value (S22), next, the file number does not return to the file 1, and the file number is made to be 2 in order to record from the file 2 (S26), recording processings for each file from the second recording on from step S22 up to step S25 are continued while deleting the contents of the respective files from the file 2 (42).

In this recording processing, due to the long time recording processings from the second recording on being started, not from the file 1, but from the file 2, the recorded information of the file 1 is made to remain as is. In accordance therewith, the user can easily know the contents of the long time recording processing by reproducing the recorded information of the file 1. Accordingly, as the sizes of the respective files, for example, one picture in moving picture information, or 1GOT, or a capacity of one second moving picture information, or the like are preferable.

Namely, in the above-described recording and reproducing apparatus, continuous picture-recording processing is stably carried out as follows. For example, at the time of recording image information or the like continuously onto a recording portion of a hard disk or the like, in the case of a conventional art, when information is recorded onto the entire recording region of the disk, thereafter, recording is repeated while deleting the information in the head region of the disk. At that time, recording and reproducing are carried out for each packet capacity which is a recording unit of recording and reproducing processing. However, because the recording is not exactly completed for each packet capacity at around the time when recorded information reaches the end portion of the recording region of the disk, one packet is picture-recorded so as to be divided into the trailing end portion and the head portion of the recording region of the disk. Therefore, in the control unit, address computation must be carried out each time, and further, a seek time of the disk is made longer, or the operation thereof is made unstable.

In the above-described recording and reproducing apparatus, in recording at the first time, the recording of the information is carried out on the entire surface of the recording region (Z₁, Z₂), and in recordings from the second recording on, the recordings are carried out at the repeated recording region (Z₂). Here, because the repeated recording region (Z₂) is integral number times of the packet capacity (188 bytes), there is no case in which a packet is divided even if recording is repeated many times. Therefore, because there is no need to carry out address computation for divided packets as in the conventional art, there is no case in which the operation is made unstable due to a seek time of a disk being made longer, and rapid and stable recording and reproducing processing is possible.

Furthermore, in the above-described latter recording and reproducing apparatus, at the time of recording information, a plurality of files (41-46) having a predetermined capacity are set, and information is continuously recorded on a hard disk or the like for each file. At that time, after information are recorded for each one of the plurality of files over the entire surface of the recording region, the file (41) recorded at the first time is made to remain, and a plurality of new files are sequentially set while deleting the files recorded from the second time on, and information is recorded for each one of the plurality of new files. Therefore, the information of the first file (41) always remains. Therefore, for example, the top picture-recorded image information at the time of the recording remains as is in the first file (41). In accordance therewith, for example, even if it is the information which has been being continuously recorded, because the user can know that, for example, recording of what program is being carried out over a long time, even the long time picture-recording, it is extremely easy to manage the information which is being recorded.

In accordance with the various embodiments described above, the skilled in the art can realize the present invention. However, it is easy for those skilled in the art to further conceive of various modified examples of these embodiments, and the present invention can be applied to various embodiments without inventive ability. Accordingly, the present invention extends over a broad range which does not contradict the disclosed principles and the novel features, and is not limited to the embodiments described above.

1. A recording and reproducing apparatus comprising:
a recording unit which has a recording region for recording information;
a computing unit which, at the time of determining addresses of respective regions of a head region which starts from a first address which is a head address of the recording region of the recording unit and ends at a second address, and a repeated recording region which starts from the second address and ends at a third address which is a last address of the recording region, determines the second address by computation such that a capacity of the repeated recording region is made to be an integral number times of a packet capacity which is a processing unit for recording and reproducing processing, and a capacity of the head region is made to be a capacity in which the capacity of the repeated region is subtracted from the capacity of the recording region; and
a control unit which, at the time of continuously recording information so as to be over the recording capacity of the recording region onto the recording unit, controls the recording unit so as to carry out recording of information onto an entire surface of the recording region from the first address up to the third address as a first recording, and so as to repeatedly continue recordings at the repeated recording region from the second address up to the third address as recordings after the recording reaches the third address, and which controls the recording unit so as to reproduce the information recorded at the recording unit.

2. A recording and reproducing apparatus according to claim 1, wherein the packet capacity which is a processing unit for the recording and reproducing processing is one of 188 bytes, 192 bytes, 130 bytes, 132 bytes, and 134 bytes.

3. A recording and reproducing apparatus according to claim 1, further comprising:
a tuner unit which outputs image information and voice information which are the information to be recorded onto the recording unit by receiving, tuning, and demodulating a broadcast signal.

4. A recording and reproducing apparatus according to claim 1, further comprising:
an optical disk drive unit which holds an optical disk, and which records and reproduces information in accordance with control of the control unit.

5. A recording and reproducing apparatus according to claim 1, wherein the capacity of the head region can store at least image information of one screen or more of moving picture information.

6. A recording and reproducing apparatus according to claim 1, further comprising:
a recording unit which has a recording region for recording information;
a computing unit which divides the recording region of the recording unit into a first region and a second region for repeated recording in a direction from a head to an end point, and which determines addresses of the respective regions such that the second region has a capacity of an integral number times of a packet capacity which is a processing unit for recording and reproducing processing; and
a control unit which, at the time of continuously recording information so as to be over the recording capacity onto the recording unit, controls the recording unit so as to carry out recording of information over an entire surface of the recording region as a first recording, so as to repeatedly continue recordings at the second region as following recordings, on the basis of the respective addresses computed at the computing unit.

7. A recording and reproducing apparatus according to claim 6, wherein the packet capacity which is a processing unit for the recording and reproducing processing is one of 188 bytes, 192 bytes, 130 bytes, 132 bytes, and 134 bytes.

8. A recording and reproducing apparatus comprising:
a recording unit which has a recording region for recording information;
a computing unit which sets files having predetermined capacities for recording the information onto the recording region of the recording unit, and which determines addresses of said plurality of files so as to store the information by said plurality of files; and
a control unit which, at the time of continuously recording information so as to be over the recording capacity onto the recording unit, controls the recording unit so as to record the information for each one of said plurality of files over an entire surface of the recording region as a first recording, and after files which can be recorded onto the recording region are recorded, so as to leave the file recorded at the first time, and to sequentially set said plurality of new files while deleting the files recorded from the second recording on, and to record the information onto the recording unit for each one of said plurality of the new files, on the basis of the respective addresses computed at the computing unit, and which controls the recording unit so as to reproduce the information recorded at the recording unit.

9. A recording and reproducing apparatus according to claim 8, wherein the capacity of the file can store at least image information of one screen or more of moving picture information.

10. A recording and reproducing method comprising:
at the time of determining addresses of respective regions of a head region which starts from a first address which is a head address of the recording region of the recording unit and ends at a second address, and a repeated recording region which starts from the second address and ends at a third address which is a last address of the recording region with respect to a recording medium having a recording region for recording information,
determining the second address by computation such that a capacity of the repeated recording region is made to be an integral number times of a packet capacity which is a processing unit for recording and reproducing processing, and a capacity of the head region is made to be a capacity in which the capacity of the repeated region is subtracted from the capacity of the recording region; and
controlling the recording medium, at the time of continuously recording information so as to be over the recording capacity of the recording region onto the recording unit, so as to carry out recording of information onto an entire surface of the recording region from the first address up to the third address as a first recording, and so as to repeatedly continue recordings at the repeated recording region from the second address up to the third address as recordings after the recording reaches the third address, and controlling the recording medium so as to reproduce the recorded information.

11. A recording and reproducing method according to claim 10, wherein the packet capacity which is a processing unit for the recording and reproducing processing is one of 188 bytes, 192 bytes, 130 bytes, 132 bytes, and 134 bytes.

12. A recording and reproducing method according to claim 10, wherein image information and voice information which have been outputted by receiving, tuning, and demodulating a broadcast signal are recorded as the information onto the recording medium.

13. A recording and reproducing method according to claim 10, wherein the information recorded on the recording medium is reproduced by controlling a driver for an optical disk provided in a case which is the same as the recording medium, and it is recorded onto the optical disk and reproduced.

14. A recording and reproducing method according to claim 10, wherein the capacity of the head region can store at least image information of one screen or more of moving picture information.
